(19) United States
(12) Patent Application Publication
(10) Pub. No.: US 2026/0215628 A1
(43) Pub. Date: Jul. 30, 2026

(54) REFILLABLE DISPENSER DEVICE

(71) Applicant: Producto Pty Ltd, Abbotsford (AU)

(72) Inventors: Samuel Clifford John BLANK, Abbotsford (AU); Kyn San LAU, Abbotsford (AU); Raymond PAR, Abbotsford (AU)

(73) Assignee: Producto Pty Ltd, Abbotsford (AU)

(21) Appl. No.: 19/039,997

(22) Filed: Jan. 29, 2025

(51) Int. Cl. A47K 5/12; B65D 77/04; B65D 77/06

(52) U.S. Cl. CPC A47K 5/1205; B65D 77/0486; B65D 77/06

(57) ABSTRACT

A refillable dispenser device from which a quantity of liquid can be dispensed by manually actuating a nozzle dispenser of the device and which, while being capable of authorised refilling with the liquid, makes difficult the unauthorised access to the liquid in the interior of the device. The device including: an inner container that defines a chamber for holding the liquid, the inner container having a base and an inner peripheral wall of the device; and an outer housing that has an outer peripheral wall and a top wall within which the inner container is accommodated via a basal opening provided adjacent to the base of the inner container. Wherein the arrangement is such that the outer housing fully accommodates the inner container, when received therein, and the inner container is not easily gripped for manual unauthorised removal of the inner container from the outer housing.

### FIELD OF THE INVENTION

This invention relates to a refillable dispenser device from which a quantity of liquid can be dispensed, as required, and which is capable of being replenished with the liquid, when needed. The refillable dispenser device of the invention is of a general type widely used for dispensing an appropriate liquid suitable, for example, for personal hygiene, or for cosmetic purposes. The liquids may be, for example, fluid soaps, hair care products or body moisturisers, or the like.

### BACKGROUND OF THE INVENTION

Any discussion of documents, devices, acts or knowledge in this specification is included to explain the context of the invention. It should not be taken as an admission that any of the material forms a part of the prior art base or the common general knowledge in the relevant art in the United States of America, or elsewhere, on or before the priority date of the disclosure herein.

Dispensing devices for liquids such as fluid soaps, hair care products and moisturisers, find wide-spread use in bathrooms of hotel accommodation, office washroom facilities, and kitchens and bathroom facilities of private houses and apartments. Typically, such dispenser devices in themselves are not designed to prevent, or deter by making difficult, the unauthorised access to the liquid contents. Instead, where it is desired to prevent, or deter by making difficult, the unauthorised access to the liquid contents, such dispensing devices are typically secured by a form of bracket in a manner that impedes such access and/or unauthorised removal of such a dispenser device and its contents from the location in which it is installed.

The present invention seeks to provide an improved or alternative form of a refillable dispenser device from which a quantity of liquid can be dispensed, as required, and which while being capable of authorised refilling with the liquid, makes difficult the unauthorised access to the liquid in the interior of the device without the need to secure the dispenser device with a bracket or the like.

### SUMMARY OF THE INVENTION

Accordingly, in one aspect, the present invention provides a refillable dispenser device from which a quantity of liquid can be dispensed, as required, by manually actuating a nozzle dispenser of the device and which, while being capable of authorised refilling with the liquid, makes difficult the unauthorised access to the liquid in the interior of the device, the refillable dispenser device relative to a usual in-use orientation including: an inner container that defines a chamber for holding a quantity of the liquid, the inner container having a base and, upstanding from the base, an inner peripheral wall of the device; and, an outer housing that has an outer peripheral wall within which the inner container is accommodated, the outer housing having an annular top wall defining an opening at which the nozzle dispenser is secured in relation to the outer housing, with a dip tube of the nozzle dispenser positioned to extend downwardly within the chamber of the inner container, the outer peripheral wall defining a basal opening adjacent to the base of the inner container; wherein the arrangement is such that the outer housing fully accommodates the inner container, after the inner container is received through the basal opening of the outer housing, and wherein despite having access to the base of the inner container, the inner container is not easily gripped for manual unauthorised removal of the inner container from the outer housing.

Preferably, sealing engagement between the inner container and the outer housing is provided between an upper edge or rim of the inner peripheral wall of the inner container and an opposed, lower underside surface of the annular top wall of the outer housing. Preferably, this sealing engagement is provided by way of an annular seal which is adhered or otherwise fixed in relation to the underside surface of the annular top wall of the outer housing, with the annular seal having a high friction surface for engagement with the upper edge or rim of the inner peripheral wall of the inner container when the inner container is fully accommodated within the outer housing.

Preferably, in one arrangement, inner surfaces of the inner peripheral wall and the base of the inner container are adapted to directly hold the liquid in the chamber. In an alternative preferred arrangement, the device is adapted to hold the liquid in the chamber in a cartridge or other container which is insertable into the inner container.

Preferably, in one arrangement, to further hinder unauthorised removal of the inner container from outer housing, the inner container preferably is held within the outer housing with neither the base of the inner container or an adjacent portion of the inner wall being manually accessible by gripping adjacent the basal opening defined by the outer peripheral wall. That is, the inner container is received in the outer housing with the exposed base of the inner container free of features able to be gripped manually. However, to further frustrate such action, the inner container and the outer housing may be in contact around opposed surfaces of the inner and outer peripheral walls.

Preferably, the inner container and the outer housing are in contact providing frictional engagement around the opposed surfaces of the of the inner and outer peripheral walls. Thus, in addition to the inner container not being easily gripped, an unauthorised person seeking to manually draw the inner container from the outer housing also needs to overcome the frictional engagement or mechanical interlocking against relative rotation, such as by an axially extending spline coupling. However, in a preferred arrangement, the opposed surfaces of the peripheral walls of the inner container and the outer housing are in engagement by threaded engagement, such as by complementary outer and inner helical thread formations respectively on the inner and outer peripheral walls. Thus, in that preferred arrangement, an unauthorised person seeking to manually draw the inner container from the outer housing is further frustrated by the need to rotate the inner container despite the inner container not being easily gripped. With the high friction surface of the preferred annular seal 19, combined with the compression created between the top rim 26 of the inner container 16 and the annular seal 19 when the inner container 16 is screwed into the outer housing 14, adding to the difficulty associated with an unauthorised person seeking to manually draw the inner container 16 from the outer housing 14 of device 10.

Preferably, the base of the inner container is configured to define a feature or formation by which an authorised person is able grip or engage the inner container, using a purpose designed tool operable to grip or engage the feature or formation to facilitate pulling and/or rotating of the inner container to achieve its separation from the outer housing; and wherein the feature or formation is difficult to grip manually without the purpose designed tool such that unauthorised separation of the inner container from the outer housing is difficult or impossible. By this means, the authorised person is able to refill the inner container or replace the cartridge or other container insertable into the inner container.

As indicated, the annular top wall of the outer housing defines an opening at which the nozzle dispenser is secured in relation to the outer housing, with the dip tube of the nozzle dispenser extending downwardly within the chamber of the inner container. This securement of the nozzle dispenser can be achieved in several ways. Typically, the outer housing has an annular collar upstanding from an inner periphery of the annular top wall of the outer housing, with that inner periphery and the upstanding collar defining the opening in which the nozzle dispenser is secured.

In one preferred arrangement, the annular collar upstanding from the inner periphery of the annular top wall of the outer housing is externally threaded to achieve initial securement of the nozzle dispenser by an internally threaded depending skirt of the nozzle dispenser being in threaded engagement with the upstanding annular collar.

Preferably, the threaded engagement between the threaded collar and the threaded skirt of the nozzle dispenser is made permanent by adhesively bonding or otherwise securing the collar and the skirt into engagement.

In an alternative preferred arrangement, by which the nozzle dispenser is secured in relation to the outer housing, the upstanding annular collar of the annular top wall and the skirt of the nozzle dispenser are not adapted for threaded inter-engagement. Rather, the upstanding annular collar has a cylindrical outer peripheral surface that is closely adjacent to a cylindrical inner peripheral surface of the skirt, with the nozzle dispenser made permanent by adhesively bonding or otherwise securing the upstanding annular collar and the skirt in engagement between the closely adjacent peripheral surfaces.

In a further alternative preferred arrangement, by which the nozzle dispenser is initially secured in relation to the outer housing by the upstanding annular collar of the annular top wall and the skirt of the nozzle dispenser being in threaded inter-engagement, the nozzle dispenser is further secured in relation to the outer housing by an annular nut held axially between a downwardly facing first land or abutment surface defined by the outer housing and an upwardly facing second land or abutment surface defined by the nozzle dispenser, and wherein the annular nut is internally threaded for threaded engagement with an external thread provided on the nozzle dispenser.

Preferably, the threads of the annular nut and the nozzle dispenser may be of the same or opposite handedness as the threaded engagement between the upstanding annular collar and the skirt, or of the same handedness. Preferably, in either case, the pitch of the internal thread of the annular nut and the external thread of the nozzle dispenser are less than the pitch of the threads providing securement between the upstanding annular collar and the skirt, particularly if the threads of the annular nut and nozzle dispenser are of the same handedness as the threads providing securement between the upstanding annular collar and the skirt. In each case, the threaded engagement of the nut preferably acts to counter or offset a force applied by an unauthorised person seeking to rotate and disengage the nozzle dispenser from the outer housing by generating torque or a rotational force resisting the force applied by the unauthorised person.

In yet a further alternative preferred arrangement, by which the nozzle dispenser is initially secured in relation to the outer housing by the upstanding annular collar of the annular top wall and the skirt of the nozzle dispenser being in threaded inter-engagement, the nozzle dispenser is further secured in relation to the outer housing by an annular sleeve secured on the dip tube, adjacent to an underside of the annular top wall of the outer housing, with the annular sleeve having a stiffly resilient annular fin that is inclined frusto-conically upwardly and outwardly from around a lower extent of the annular sleeve, such that, as the nozzle dispenser is inserted to receive the dip tube through the opening of the annular top wall of the outer housing, to receive the dip tube into the chamber, the annular fin is compressed in passing through that opening, and thereafter the fin resiliently recovers its frustoconical form to abut against the underside of the annular top wall of the outer housing, holding against separation of the nozzle dispenser from the outer housing.

In still yet a further alternative preferred arrangement, by which the nozzle dispenser is secured in relation to the outer housing, the upstanding annular collar of the annular top wall and the skirt of the nozzle dispenser are not adapted for threaded inter-engagement. Rather, the upstanding annular collar has a cylindrical outer peripheral surface that is closely adjacent to a cylindrical inner peripheral surface of the skirt, with the nozzle dispenser being permanently secured in relation to the outer housing by an annular sleeve secured on the dip tube, adjacent to an underside of the annular top wall of the outer housing, with the annular sleeve having a stiffly resilient annular fin that is inclined frusto-conically upwardly and outwardly from around a lower extent of the annular sleeve, such that, as the nozzle dispenser is inserted to receive the dip tube through the opening of the annular top wall of the outer housing, to receive the dip tube into the chamber, the annular fin is compressed in passing through that opening, and thereafter the fin resiliently recovers its frustoconical form to abut against the underside of the annular top wall of the outer housing, holding against separation of the nozzle dispenser from the outer housing.

Preferably, the feature or formation defined on the base of the inner container comprises a pair of substantially parallel lugs that depend from an underside of the base of the inner container, each lug aligned with a respective one of a pair of recesses defined in a peripheral rim around the underside of the base of the inner container whereby the inner container can be securely engaged and axially pulled with respect to the outer housing, by a bent or curved elongate tool having prongs projecting from one end by each of the prongs located in a respective recess and the tool manoeuvred while retaining the prongs located in the recesses to locate an adjacent part of its length between the lugs and then rotated and pulled.

In an alternative form, it is preferred that the feature or formation defined on the base of the inner container comprises a pair of substantially parallel elongate lugs or recesses that extend on or in and across an underside of the base of the inner container, within a peripheral rim around the underside of the base of the inner container, whereby the inner container can be rotated by a tool comprising a plate having a raised, circular land neatly receivable against the underside of the base of the inner container, with the circular land neatly received within the peripheral rim each of a pair of substantially parallel recesses or ribs that extend in or on and across the land located on or in a respective one of the parallel elongate lugs or recesses such that the inner container is rotatable relative to the outer housing with rotation of the tool with the recesses or ribs mating with the ribs or recesses formed in the base of the inner container

These and other essential or preferred features of the present invention will be apparent from the description that now follows.

### BRIEF DESCRIPTION OF THE DRAWINGS

In order that the invention may be more clearly understood and put into practical effect there shall now be described in detail preferred refillable dispenser devices made in accordance with preferred embodiments of the present invention. The ensuing description is given by way of non-limitative examples only and is with reference to the accompanying drawings, wherein:

FIG. 1 is perspective view of a refillable dispenser device made in accordance with a preferred embodiment of the present invention, shown in a normal in-use orientation;

FIG. 2 a top plan view of the refillable dispenser device of FIG. 1;

FIG. 3 is a side elevation of the refillable dispenser device of FIG. 1;

FIG. 4 is an axial sectional view of the refillable dispenser device of FIG. 1, taken in a plane along lines 4-4 of FIG. 2;

FIG. 5 is an exploded perspective view of preferred components of the refillable dispenser device of FIG. 1;

FIG. 6a shows a partial sectional view of one preferred arrangement for securement of components shown in FIG. 5;

FIG. 6b corresponds to FIG. 6a, but shows a further preferred arrangement for securement of components shown in FIG. 5;

FIG. 6c corresponds to FIGS. 6a & 6b, but shows yet a further preferred arrangement for securement of components shown in FIG. 5;

FIG. 7 corresponds to FIG. 4, but illustrates an alternative preferred use of the refillable dispenser device of FIG. 1;

FIG. 8 is a partial exploded perspective view of the device of FIG. 1, illustrating authorised refilling of the refillable dispenser device in accordance with the preferred alternative use of the device illustrated in FIG. 7;

FIG. 9 is a partial exploded perspective view of the refillable dispenser device of FIG. 1, depicted as rotated approximately 90 degrees from the normal in-use orientation shown in FIG. 1, and illustrating a preferred tool enabling authorised assembly and disassembly of the device to enable refilling as shown in, for example, FIG. 8;

FIG. 10 is an exploded perspective view of the refillable dispenser device of FIG. 1, shown partly in cross-section, providing an alternative view to that of FIG. 9 and a depiction of use of the preferred tool shown in FIG. 9;

FIG. 11 is a perspective view of an alternative preferred form of a tool enabling authorised assembly and disassembly of the refillable dispensing device of FIG. 1; and,

FIG. 12 corresponds to FIG. 10 but illustrates use of the alternative preferred tool shown in FIG. 11.

### MODES FOR CARRYING OUT THE INVENTION

In the following detailed description of the invention, reference is made to the drawings in which like reference numerals refer to like elements throughout, and which are intended to show by way of illustration specific embodiments in which the invention may be practiced. It is to be understood that other embodiments may be utilised and that procedural and/or structural changes may be made without departing from the spirit and scope of the invention.

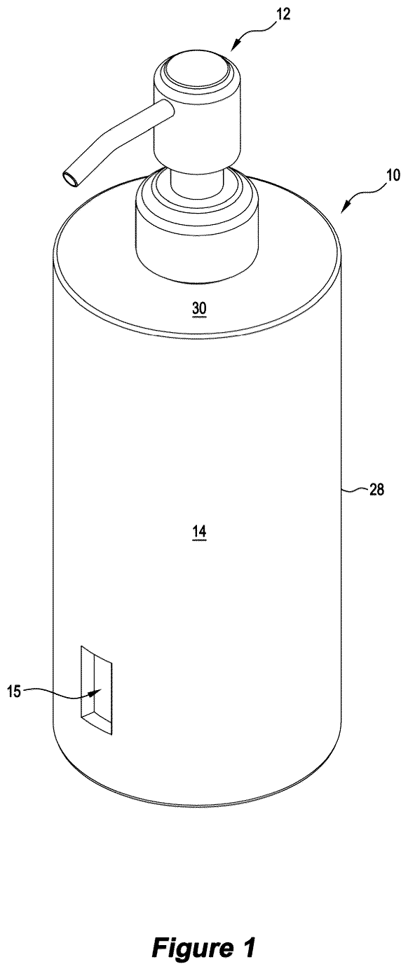

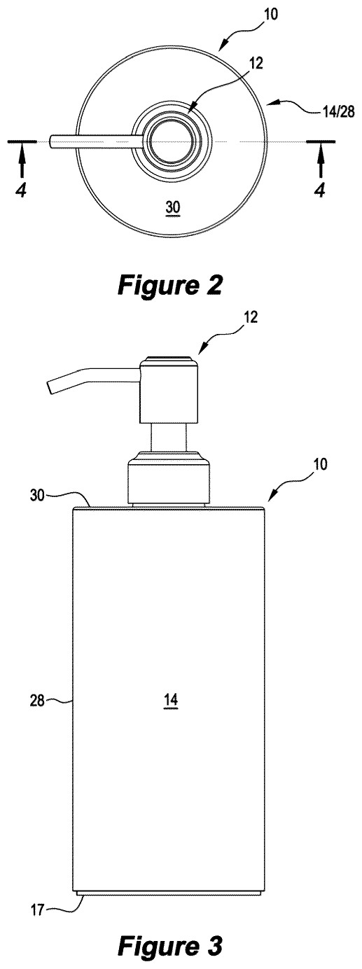

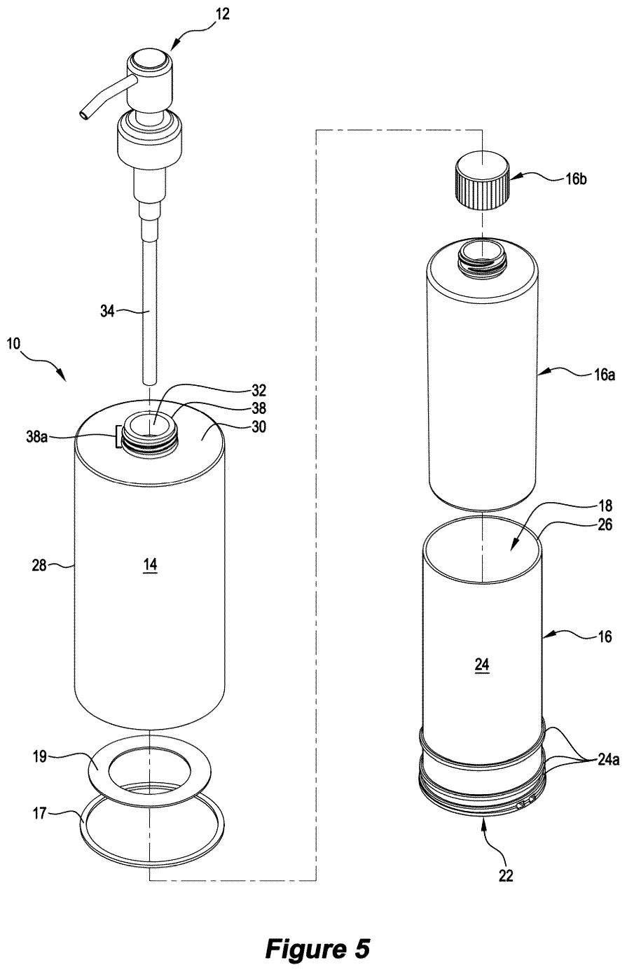

With reference to FIGS. 1 to 5, there is shown a refillable dispenser device 10 (hereinafter simply referred to as “device 10”) made in accordance with one preferred form of the present invention. The device 10 enables successive quantities of a liquid 20 (see, for example, FIG. 4) to be dispensed as required from a nozzle dispenser 12 of the device 10, as required, by manually actuating nozzle dispenser 12. The device 10 has a usual in-use orientation as shown in FIG. 1 and terms such as “top”, “upper”, “inner”, “outer”, and “downwardly” are to be understood as applicable to that orientation in the context of a convention 3-axis co-ordinate system having a vertical, or substantially vertical, z-axis.

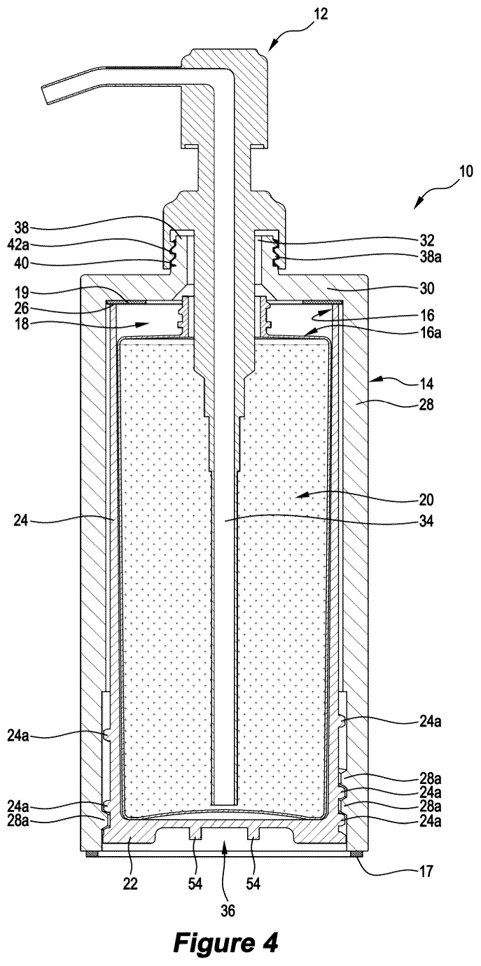

Device 10 has an outer housing 14 and, as shown in FIG. 4, an inner container 16 accommodated within outer housing 14. The inner container 16 defines a chamber 18 for holding a quantity of a liquid 20. The inner container 16 has a base wall 22, an inner peripheral wall 24 upstanding from the base wall 22, and a top rim 26. The outer housing 14 has an outer peripheral wall 28 within which the inner container 16 is accommodated and an annular top wall 30 defining an opening 32 at which the nozzle dispenser 12 is secured in relation to the outer housing 14, with a dip tube 34 of the nozzle dispenser 12 positioned to extend downwardly within the chamber 18 of the inner container 16. The outer peripheral wall 28 of outer housing 14 defines a basal opening 36 through which the inner container 16 is received into the outer housing 14, with the arrangement such that the base wall 22 of the inner container 16 is adjacent to the basal opening 36 defined by the outer peripheral wall 28. The device 10 may be provided with an anti-slip foot ring 17 adhered to and around the base of the outer housing 14, as shown in FIGS. 3 to 5, 7, 9, 10 and 12, so that in use the device 10 does not easily slip on a support surface (not shown).

As shown in FIG. 1, device 10 preferably also includes a viewing window 15 provided in the outer peripheral wall 28 of outer housing 14 so that an inspection of the level of liquid 20 within inner container 16 may be made as desired. It will be appreciated that for such a viewing window 15 to be of use, the inner peripheral wall 24 of inner container 16 needs to be made of at least a partially transparent material. It will be appreciated that such a viewing window 15 or multiple such viewing windows (not shown) may be sized, shaped and positioned at any suitable location on outer peripheral wall 28 of outer housing 14, but it is preferred that a single viewing window 15 is provided toward the base of outer housing 14 so that it is possible to inspect when the liquid 20 level is low.

Device 10 can hold an appropriate quantity of liquid 20 suitable for any of a range of uses such as personal hygiene and cosmetic purposes, such as, but not limited to, fluid soaps, hair care products or body moisturisers. Such devices 10 find wide-spread use in bathrooms of hotel accommodation, office washroom facilities, and kitchens and bathroom facilities of private houses and apartments. Device 10 is capable of authorised refilling with the liquid 20 but, as detailed herein, device 10 is designed to make difficult the unauthorised access to the liquid 20 in the interior (chamber 18) of the device 10.

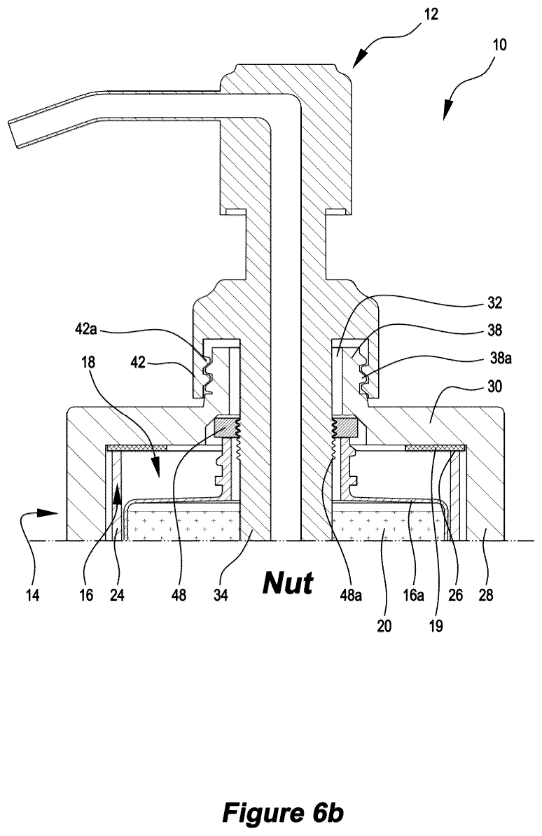

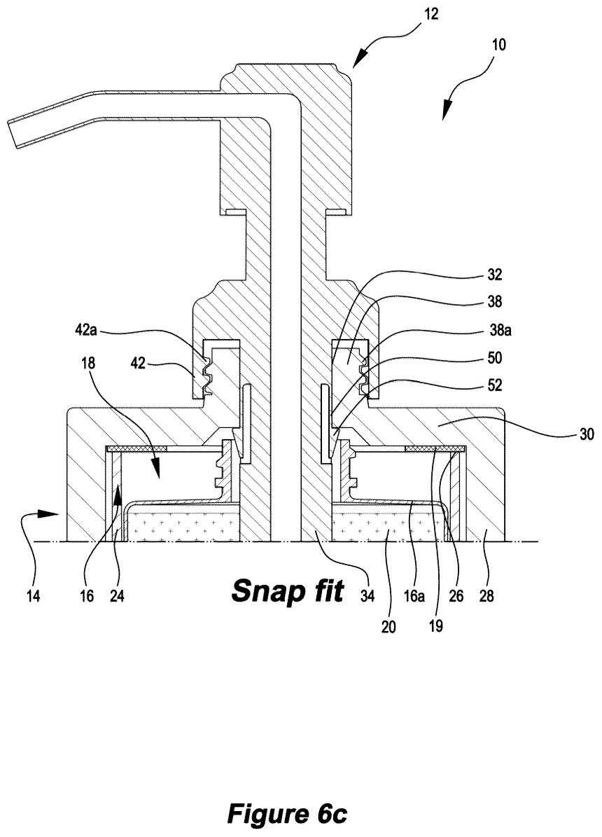

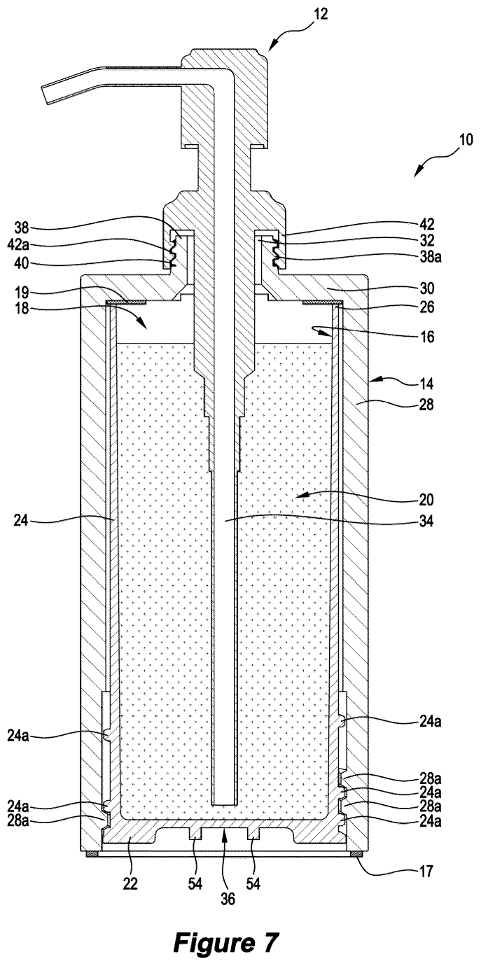

Device 10 can be used as a counter-top refillable dispenser bottle used in either of two preferred ways, with a single use or refillable amenity product cartridge or container 16a provided for insertion within inner container 16 (after removal of a closure 16b) as shown in FIGS. 4 to 6c, or by refilling and reusing the inner container 16 with an amenity product (liquid 20) from a bulk source or bottle 20a as shown in FIGS. 7 and 8. In each case, the nozzle dispenser 12 is non-removable and remains secured to the outer housing 14, as detailed later herein with reference to FIGS. 6a, 6b and 6c. Whilst a single use or refillable amenity product cartridge or container 16a having a removable closure 16b is shown and described, it will be appreciated that instead of a removable closure 16b, cartridge or container 16a may instead be sealed with a film or foil seal (not shown) that is either removable like closure 16b, or is penetrable by the dip tube 34 when the inner container 16 with the cartridge or container 16a is inserted into outer housing 14 of device 10.

In the preferred arrangement of device 10 shown in FIGS. 4 to 7, in which the inner container 16 is open-topped and closed (when inserted into outer housing 14 of device 10) at its top rim 26 by the underside of the annular top wall 30 of the outer housing 14, an annular seal 19 is preferably provided to seal between the top rim 26 of the inner container 16 and that underside of the annular top wall 30, to safeguard against liquid 20 leakage. Annular seal 19 is preferably adhered or otherwise fixed in relation to the underside of the annular top wall 30 of outer housing 14 and preferably includes a high friction surface for engagement with the top rim 26 of the inner container 16 of device 10.

The arrangement of device 10 as shown in FIGS. 1 to 5, as in other embodiments, is such that the outer housing 14 fully accommodates the inner container 16, after the inner container 16 is received through the basal opening 36 of the outer housing 14, as shown most clearly in FIG. 4. The inner container 16 is so receivable in an arrangement achieving sealing engagement between the top rim 26 of the inner container 16 and the underside of the annular top wall 30 of the outer housing 14, around the opening 32 of the annular top wall 30 at which the nozzle dispenser 12 is secured in relation to the outer housing 14. With this sealing engagement being preferably provided by way of the annular seal 19 that is adhered or otherwise fixed in relation to the underside of the annular top wall 30 of outer housing 14 of device 10.

In device 10, the inner container 16 is received in the outer housing 14 in a manner such that, despite there being access to the base wall 22 of inner container 16, an unauthorised person is not readily able to grip the inner container 16 manually in seeking to remove the inner container 16 from the outer housing 14 of device 10. To frustrate such action, the inner container 16 preferably is held within the outer housing 14 with neither the base wall 22 of the inner container 16 or an adjacent lower portion of the inner wall 24 of the inner container 16 being manually accessible adjacent the basal opening 36 defined by the outer peripheral wall 28 of the outer container 14. However, to further frustrate such action, the inner container 16 and the outer housing 14 may be in contact around opposed surfaces of the inner and outer peripheral walls 24 and 28.

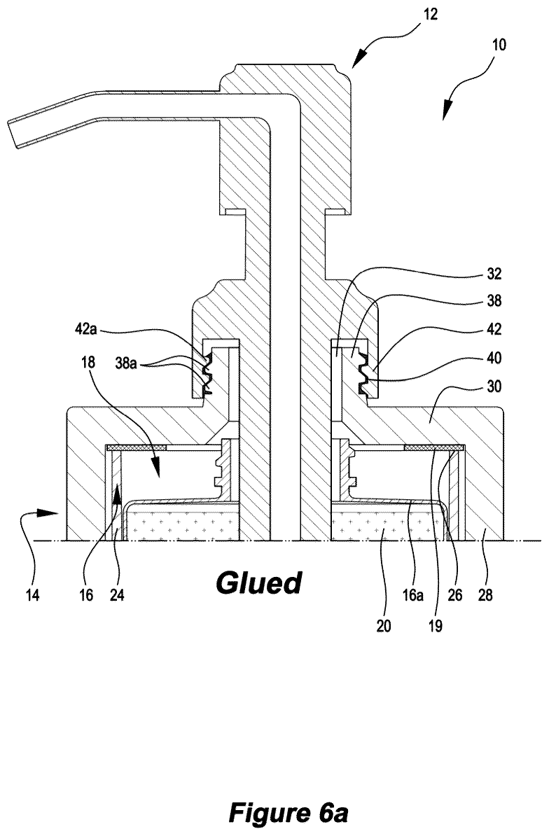

In one preferred arrangement of device 10, the inner container 16 and the outer housing 14 are in contact providing frictional engagement around the opposed surfaces of the respective inner and outer peripheral walls 24 and 28. Thus, in addition to the inner container 16 not being easily gripped, the arrangement preferably is such that a person seeking to manually draw the inner container 16 from the outer housing 14 also would need to overcome the frictional engagement. Such a preferred arrangement is shown in FIG. 4, and similarly in each of FIG. 5 and FIGS. 7 to 10. In this preferred arrangement, the opposed surfaces of the peripheral walls 24 and 28, of the inner container 16 and the outer housing 14, respectively, are in threaded engagement enabled by complementary helical thread formations 24a and 28a, respectively on the inner and outer peripheral walls 24 and 28. Thus, in that preferred arrangement, a person seeking to manually draw the inner container 16 from the outer housing 14 is further frustrated by the need to rotate the inner container 16 relative to the outer housing 14 despite the inner container 16 not being easily gripped. With the high friction surface of the preferred annular seal 19, combined with the compression created between the top rim 26 of the inner container 16 and the annular seal 19 when the inner container 16 is screwed into the outer housing 14, adding to the difficulty associated with an unauthorised person seeking to manually draw the inner container 16 from the outer housing 14 of device 10.

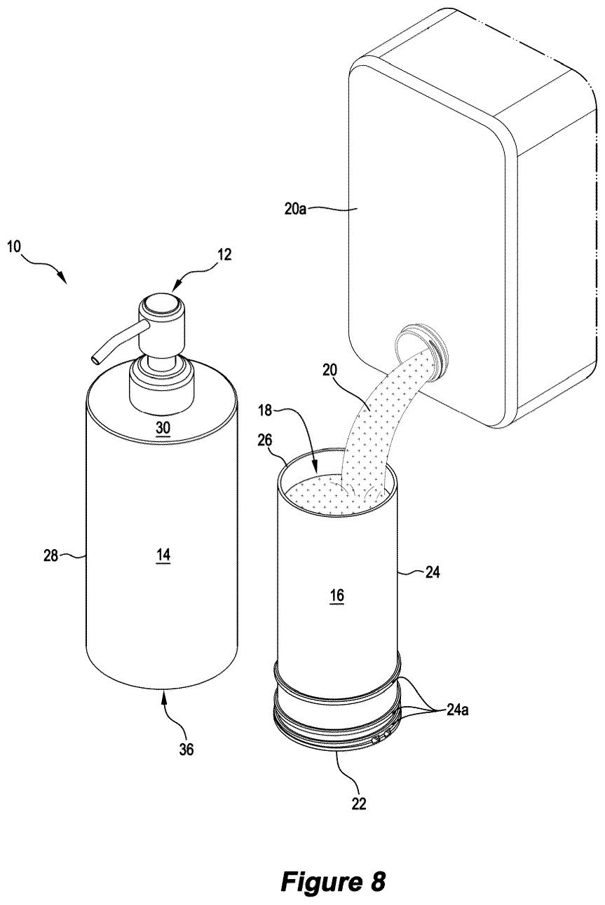

With or without such threaded engagement between the inner container 16 and the outer housing 14 of device 10, the lower end base wall 22 of the inner container 16 preferably is configured to define a feature or formation by which an authorised person is able to grip or engage the inner container 16, using a tool that is a purpose designed tool operable to grip or engage the feature or formation of inner container 16 to facilitate pulling and/or rotating the inner container 16 to achieve its separation from the outer housing 14. By this means, the authorised person is able to refill the inner container 16 or replace the single use or refillable cartridge or container 16a if device 10 is used with such a cartridge or container 16a. Forms for and use of tools for this purpose are shown in and described later herein with reference to FIGS. 9 to 12.

As indicated hereinbefore, the annular top wall 30 of outer housing 14 of device 10 defines an opening 32 at which the nozzle dispenser 12 is secured in relation to the outer housing 14, with the dip tube 34 of the nozzle dispenser 12 extending downwardly within the chamber 18 of the inner container 16, or within the single use or refillable cartridge or container 16a inserted within inner container 16, so that the liquid 20 contents contained therein may be dispensed as desired. In each illustrated arrangement of the drawings, this securement of the nozzle dispenser 12 is achieved by the outer housing 14 having an annular collar 38 upstanding from the inner periphery of the annular top wall 30 of the outer housing 14, with that inner periphery and the upstanding collar 38 defining the opening 32 in which the nozzle dispenser 12 is secured.

A first preferred arrangement for securing nozzle dispenser 12 to outer housing 14 of device 10 is shown most clearly in FIG. 6a. In this first preferred arrangement, the upstanding annular collar 38 of outer housing 14 has an external helical thread 38a by which initial securement of the nozzle dispenser 12 is enabled by the nozzle dispenser 12 having a depending skirt 42 having an internal helical thread 42a and the skirt 42 of the nozzle dispenser 12 in threaded engagement with the collar 38. In this first preferred arrangement by which the nozzle dispenser 12 is secured in relation to the upstanding annular collar 38 of the outer housing 14, the threaded engagement between the external thread 38a of the annular collar 38 and the internal thread 42a of the skirt 42 of the nozzle dispenser 12 is made permanent by adhesively bonding or otherwise securing the annular collar 38 and the skirt 42 in engagement, as depicted by the undulating thickened line 40 shown between annular collar 38 and skirt 42.

A second preferred arrangement by which the nozzle dispenser 12 may be secured in relation to the outer housing 14 of device 10, is not shown but corresponds to the first preferred arrangement shown in FIG. 6a. In this second preferred arrangement, the upstanding annular collar 38 of the annular top wall 30, of outer housing 14, and the skirt 42 of the nozzle dispenser 12 are not adapted for threaded inter-engagement. Rather, the annular collar 38 has an outer peripheral surface that is closely adjacent to an inner peripheral surface of the skirt 42, with the nozzle dispenser 12 engagement made permanent by adhesively bonding or otherwise securing the annular collar 38 and the skirt 42 in engagement between the closely adjacent peripheral surfaces, as depicted similarly by the thickened line 40 shown between annular collar 38 and skirt 42 shown in FIG. 6a.

A third preferred arrangement for securing nozzle dispenser 12 to outer housing 14 of device 10 is shown in FIG. 6b. Like in the case of the first preferred arrangement, the third preferred arrangement again has the upstanding annular collar 38 of top wall 30 of outer housing 14, with which the skirt 42 of the nozzle dispenser 12 is in threaded inter-engagement. However, this third preferred arrangement differs from the first and second preferred arrangements in that it does not rely on adhesive bonding or other permanent securement between the annular collar 38 and the skirt 42 that acts to prevent rotation enabling separation of the nozzle dispenser 12 from the outer housing 14 of device 10. Rather, this third preferred arrangement includes an annular nut 48 that is held axially between a first land or abutment surface defined by the outer housing 14, such as at the junction between the annular top wall 30 and the upstanding annular collar 38, and a second land or abutment surface defined by the nozzle dispenser 12, such as around the dip tube 34 of the nozzle dispenser 12. The annular nut 48 is internally threaded (not shown) for threaded engagement with an external thread 48a provided on the nozzle dispenser 12. The threads of the annular nut 48 and dip tube 34 may of the same or opposite handedness as the threaded engagement between the annular collar 38 and the skirt 42, or of the same handedness. In either case, the pitch of the internal thread (not shown) of the annular nut 48 and the external thread 48a provided on the dip tube 34 of nozzle dispenser 12 preferably is less than the pitch of the threads 38a & 42a providing securement between the annular collar 38 and the skirt 42, particularly if the threads of the annular nut 48 and nozzle dispenser 12 are of the same handedness as the threads 38a & 42a providing securement between the annular collar 38 and the skirt 42. In each case, the threaded engagement of the annular nut 48 and nozzle dispenser 12 acts to counter or offset a force applied by an unauthorised person seeking to rotate and disengage the nozzle dispenser 12 from the outer housing 14 by generating torque or a rotational force resisting the force applied by the unauthorised person.

A fourth preferred arrangement for securing nozzle dispenser 12 to outer housing 14 of device 10 is shown in FIG. 6c. In this fourth preferred arrangement, an annular sleeve 50 is secured on the dip tube 34, adjacent to the underside of the annular top wall 30 of outer housing 14 of device 10, with the annular sleeve 50 having a stiffly resilient annular fin 52 that is inclined frusto-conically upwardly and outwardly from around a lower extent of the annular sleeve 50. The arrangement is such that, as the nozzle dispenser 12 is inserted through the opening 32 of annular top wall 30 of outer housing 14, to receive the dip tube 34 into the chamber 18 (or into the single use or refillable cartridge or container 16a inserted within the chamber 18 of the inner container 16), the annular fin 52 is compressed in passing through that opening 32, and thereafter the fin 52 resiliently recovers its frustoconical form. The recovered form of the fin 52 and securement of the annular sleeve 50 on the dip tube 34 is such that the fin 52 abuts against the underside of the annular top wall 30 of outer housing 14, to preclude separation of the nozzle dispenser 12 from the outer housing 14 of device 10. Whilst this fourth preferred arrangement is shown in FIG. 6c as including a threaded inter-engagement between the upstanding annular collar 38 of the annular top wall 30 of outer housing 14 and the skirt 42 of the nozzle dispenser 12, it will be appreciated that in an alternative form (not shown) of device 10, the upstanding annular collar 38 of the annular top wall 30 of outer housing 14 and the skirt 42 of the nozzle dispenser 12 may not be adapted for threaded inter-engagement. But instead, like in the second preferred arrangement described hereinbefore, the annular collar 38 may have an outer peripheral surface that is closely adjacent to an inner peripheral surface of the skirt 42 of nozzle dispenser 12.

As hereinbefore described, device 10 is intended to be refillable with a liquid 20 (either directly into the chamber 18 of the inner container 16 as shown in, for example, FIGS. 7 & 8, or by inserting a cartridge or container 16a into the chamber 18 of inner container 16), and authorised action to enable this is intended. For authorised action enabling refilling, the base wall 22 of inner container 16 is provided with at least one formation that is difficult to use for separation of the inner container 16 from the outer housing 14 of device 10 without recourse to a purpose designed tool engageable with the formation to enable application of a longitudinal force or a pulling action.

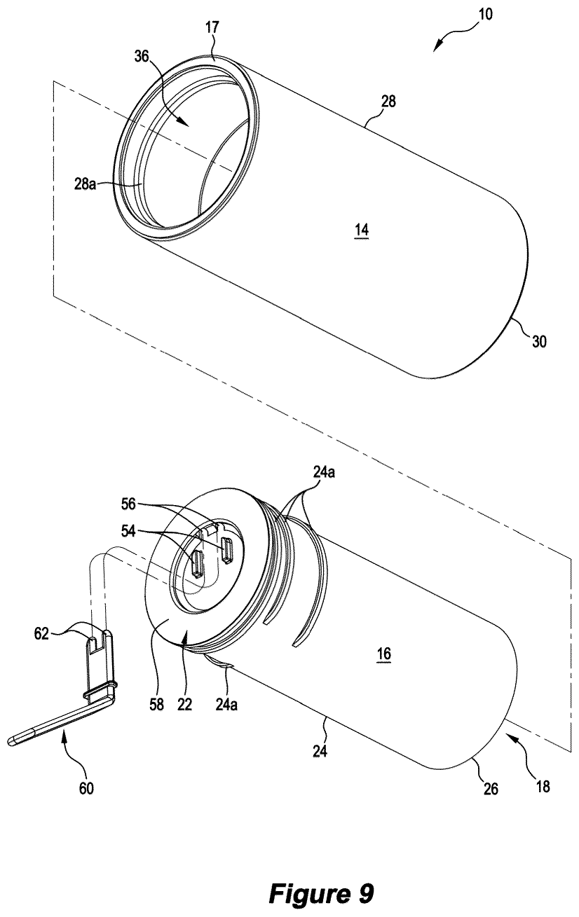

In one preferred arrangement shown in FIGS. 9 and 10, the formations may comprise a pair of substantially parallel lugs 54 that depend from an underside of the base wall 22 of the inner container 16, with each lug 54 aligned with a respective one of a pair of recesses 56 defined in a peripheral rim 58 around the underside of the base wall 22 of the inner container 16. The arrangement is such that the inner container 16 can be securely engaged, to enable it to be pulled axially with respect to the outer housing 14, by a preferred bent or curved elongate tool 60 having prongs 62 projecting from one end. The arrangement is such that, with each of the prongs 62 located in a respective recess 56, as designed, the tool 60 can be manoeuvred while retaining each prong 62 located in a corresponding recess 56 to locate an adjacent part of its length between the lugs 54 and then rotated (as indicated by arrows A-A in FIG. 10) and pulled as required to remove inner container 16 from outer housing 14 of device 10.

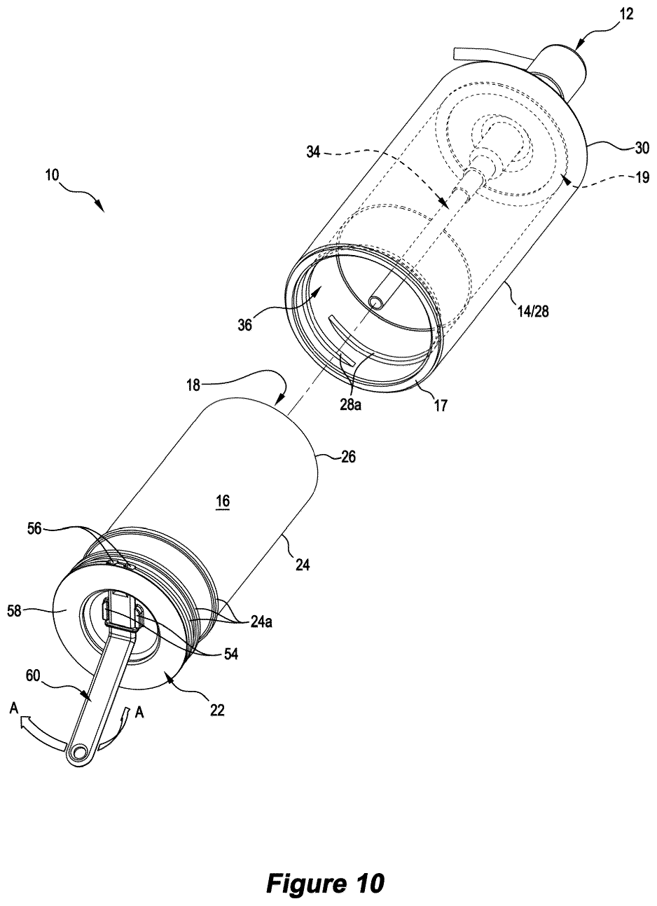

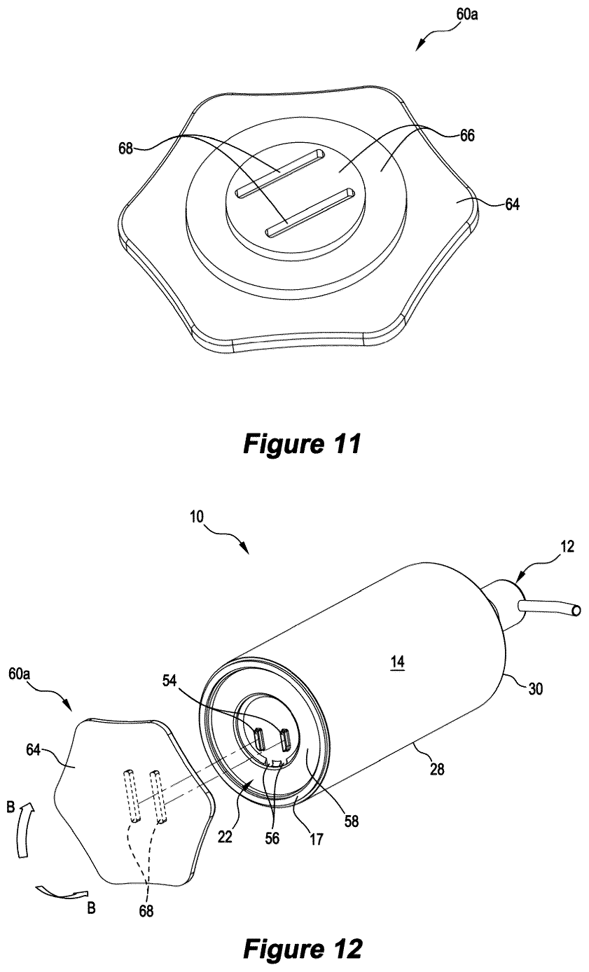

In another preferred arrangement shown in FIGS. 11 and 12, the formation again comprises a pair of substantially parallel lugs 54 that depend from the underside of the base wall 22 of the inner container 16. This alternative preferred arrangement is such that the inner container can be rotated by an alternative preferred tool 60a comprising a plate 64 having a raised, stepped circular land 66 that is neatly receivable against the underside of the base wall 22 of the inner container 16, with the upper step of the circular land 66 neatly received within the peripheral rim 58, with each of a pair of substantially parallel recesses 68 that extend into the upper step of the circular land 66 located and engageable with a respective one of the parallel lugs 54 provided on the base wall 22, so that rotation (as indicated by arrows B-B in FIG. 12) of preferred alternative tool 60a on the axis of outer housing 14 rotates the inner container 16 relative to the outer housing 14 of device 10, so that the inner container 16 may be removed for refilling of liquid 20 as desired or needed.

Whilst not shown in the drawings, in yet a further preferred arrangement similar to that shown in FIGS. 11 & 12, instead of the base wall 22 of inner container 16 being provided with a pair of substantially parallel lugs 54, base wall 22 may instead comprise a pair of substantially parallel elongate recesses (not shown) that extend in and across the underside of the base wall 22 of the inner container 16, within the peripheral rim 58 that extends around the underside of the base wall 22 of the inner container 16. This alternative preferred arrangement (not shown) is such that a further alternative tool (not shown) similar to that of alternative tool 60a shown in FIGS. 11 & 12 may comprise a pair of substantially parallel ribs (not shown) that extend across the upper step of the circular land 66 located and engageable in a respective one of the parallel elongate recesses (now shown), so that rotation of the further alternative tool (not shown) on the axis of outer housing 14 rotates the inner container 16 relative to the outer housing 14 of device 10, so that the inner container 16 may be removed for refilling of liquid 20 as desired or needed.

Whilst preferred arrangements of features or formations by which an authorised person is able to grip or engage the inner container 16, for removing the inner container 16 from the outer housing 14 of device 10, and preferred tools for use therewith, are shown and described herein, it will be appreciated that the present invention is not limited to just those specific arrangements. Other suitable arrangements (not shown), such as, for example, a singular lug or recess provided on or in the base wall 22 of inner container, and a mating singular recess or lug provided in or on an alternative tool, could instead be used for facilitating authorised removal of the inner container 16 from the outer housing 14 of device 10. Similarly, more than two lugs or recesses on the base 22 of inner container 16 which mate with more than two recesses or lugs on an alternative tool may also be utilised in accordance with the present invention. It will also be appreciated that other alternative geometric shaped features or formations may also be utilised in accordance with the present invention, such as square, triangular and/or hexagon shaped features or formations. A skilled person will appreciate these and other alternative arrangements of suitable features or formations for use with device 10 of the present invention. Accordingly, the present invention should not be construed as limited to the specific examples provided herein.

While a perspective view of the nozzle dispenser 12 is depicted in FIGS. 1 to 3, 5, 8, 10 and 12, its component parts are not distinguished in the shaded sectional views of FIGS. 4, 6a, 6b, 6c and 7. However, the specific, detailed structure of nozzle dispenser 12 other than as detailed herein is not material to the advance provided by the present invention, and the nozzle dispenser 12 can be of any commonly used suitable form. As is well understood, and as elaborated in the entry under “soap dispenser” viewable via Wikipedia, under the sub-heading “Parts”, nozzle dispensers 12 of suitable form are mounted in relation to a liquid closure (the inner container 16 of the present invention) and have an actuator that is pressed down to express a quantity of liquid 20, an actuator housing containing interior components (a spring, ball, piston or stem that moves liquid to the actuator) and a dip tube 34.

While this invention has been described in connection with specific embodiments thereof, it will be understood that it is capable of further modification. The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

1. A refillable dispenser device from which a quantity of liquid can be dispensed, as required, by manually actuating a nozzle dispenser of the device and which, while being capable of authorised refilling with the liquid, makes difficult the unauthorised access to the liquid in the interior of the device, the refillable dispenser device relative to a usual in-use orientation including:
an inner container that defines a chamber for holding a quantity of the liquid, the inner container having a base and, upstanding from the base, an inner peripheral wall of the device; and,
an outer housing that has an outer peripheral wall within which the inner container is accommodated, the outer housing having an annular top wall defining an opening at which the nozzle dispenser is secured in relation to the outer housing, with a dip tube of the nozzle dispenser positioned to extend downwardly within the chamber of the inner container, the outer peripheral wall defining a basal opening adjacent to the base of the inner container;
wherein the arrangement is such that the outer housing fully accommodates the inner container, after the inner container is received through the basal opening of the outer housing, and wherein despite having access to the base of the inner container, the inner container is not easily gripped for manual unauthorised removal of the inner container from the outer housing.

2. The refillable dispenser device of claim 1, wherein sealing engagement between the inner container and the outer housing is provided between an upper edge or rim of the inner peripheral wall of the inner container and an opposed, lower underside surface of the annular top wall of the outer housing.

3. The refillable dispenser device of claim 2, wherein the sealing engagement is provided by way of an annular seal which is adhered or otherwise fixed in relation to the underside surface of the annular top wall of the outer housing, with the annular seal having a high friction surface for engagement with the upper edge or rim of the inner peripheral wall of the inner container when the inner container is fully accommodated within the outer housing.

4. The refillable dispenser device of claim 1, wherein inner surfaces of the inner peripheral wall and the base of the inner container are adapted to directly hold the liquid in the chamber.

5. The refillable dispenser device of claim 1, wherein the device is adapted to hold the liquid in the chamber in a cartridge or other container which is insertable into the inner container.

6. The refillable dispenser device of claim 1, wherein the inner container is received in the outer housing with an exposed portion of the base of the inner container free of features able to be readily gripped manually.

7. The refillable dispenser device of claim 1, wherein the inner container and the outer housing are in contact providing frictional engagement around the opposed surfaces of the inner and outer peripheral walls.

8. The refillable dispenser device of claim 1, wherein opposed surfaces of the of the inner and outer peripheral walls of the inner container and the outer housing are in threaded engagement by complementary outer and inner helical thread formations respectively on the opposed surfaces of the inner and outer peripheral walls.

9. The refillable dispenser device of claim 1, wherein the base of the inner container is configured to define a feature or formation by which an authorised person is able grip or engage the inner container, using a purpose designed tool operable to grip or engage the feature or formation to facilitate pulling and/or rotating of the inner container to achieve its separation from the outer housing; and wherein the feature or formation is difficult to grip manually without the purpose designed tool such that unauthorised separation of the inner container from the outer housing is difficult or impossible.

10. The refillable dispenser device of claim 1, wherein the outer housing has an annular collar upstanding from an inner periphery of the annular top wall, with that inner periphery and the upstanding annular collar defining the opening in which the nozzle dispenser is secured, and wherein the upstanding annular collar is externally threaded to achieve initial securement of the nozzle dispenser by an internally threaded, depending skirt of the nozzle dispenser being in threaded engagement with the upstanding annular collar.

11. The refillable dispenser device of claim 10, wherein the nozzle dispenser is further secured in relation to the outer housing by the threaded engagement between the threaded updating annular collar and the threaded skirt of the nozzle dispenser being secured by adhesively bonding or otherwise securing the upstanding annular collar and the skirt into engagement.

12. The refillable dispenser device of claim 10, wherein the nozzle dispenser is further secured in relation to the outer housing by an annular nut held axially between a downwardly facing first land or abutment surface defined by the outer housing and an upwardly facing second land or abutment surface defined by the nozzle dispenser, and wherein the annular nut is internally threaded for threaded engagement with an external thread provided on the nozzle dispenser, with the internal threading of the annular nut and the external thread provided on the nozzle dispenser having a pitch of less than the pitch of the threads providing securement between the upstanding annular collar and the skirt.

13. The refillable dispenser device of claim 10, wherein the nozzle dispenser is further secured in relation to the outer housing by an annular sleeve secured on the dip tube, adjacent to an underside of the annular top wall of the outer housing, with the annular sleeve having a stiffly resilient annular fin that is inclined frusto-conically upwardly and outwardly from around a lower extent of the annular sleeve, such that, as the nozzle dispenser is inserted to receive the dip tube through the opening of the annular top wall of the outer housing, to receive the dip tube into the chamber, the annular fin is compressed in passing through that opening, and thereafter the fin resiliently recovers its frustoconical form to abut against the underside of the annular top wall of the outer housing, holding against separation of the nozzle dispenser from the outer housing.

14. The refillable dispenser device of claim 1, wherein the outer housing has an annular collar upstanding from an inner periphery of the annular top wall of the outer housing, with that inner periphery and the upstanding collar defining the opening in which the nozzle dispenser is secured, and wherein the nozzle dispenser is secured in relation to the outer housing by an annular sleeve secured on the dip tube, adjacent to an underside of the annular top wall of the outer housing, with the annular sleeve having a stiffly resilient annular fin that is inclined frusto-conically upwardly and outwardly from around a lower extent of the annular sleeve, such that, as the nozzle dispenser is inserted to receive the dip tube through the opening of the annular top wall of the outer housing, to receive the dip tube into the chamber, the annular fin is compressed in passing through that opening, and thereafter the fin resiliently recovers its frustoconical form to abut against the underside of the annular top wall of the outer housing, holding against separation of the nozzle dispenser from the outer housing.

15. The refillable dispenser device of claim 9, wherein the feature or formation defined on the base of the inner container comprises a pair of substantially parallel lugs that depend from an underside of the base of the inner container, each lug aligned with a respective one of a pair of recesses defined in a peripheral rim around the underside of the base of the inner container whereby the inner container can be securely engaged and axially pulled with respect to the outer housing, by a bent or curved elongate tool having prongs projecting from one end by each of the prongs located in a respective recess and the tool manoeuvred while retaining the prongs located in the recesses to locate an adjacent part of its length between the lugs and then rotated and pulled.

16. The refillable dispenser device of claim 9, wherein the feature or formation defined on the base of the inner container comprises a pair of substantially parallel elongate lugs or recesses that extend on or in and across an underside of the base of the inner container, within a peripheral rim around the underside of the base of the inner container, whereby the inner container can be rotated by a tool comprising a plate having a raised, circular land neatly receivable against the underside of the base of the inner container, with the circular land neatly received within the peripheral rim each of a pair of substantially parallel recesses or ribs that extend in or on and across the land located on or in a respective one of the parallel elongate lugs or recesses such that the inner container is rotatable relative to the outer housing with rotation of the tool with the recesses or ribs mating with the ribs or recesses formed in the base of the inner container.
